(19) United States
(12) Patent Application Publication
(10) Pub. No.: US 2007/0248528 A1
(43) Pub. Date: Oct. 25, 2007

(54) Method for the Preparation of High Purity Carbon Nanotubes Using Water

(76) Inventor: Young Nam Kim, Seoul (KR)

Correspondence Address: BLAKELY SOKOLOFF TAYLOR & ZAFMAN, 1279 OAKMEAD PARKWAY, SUNNYVALE, CA, 94085-4040, US

(21) Appl. No.: 10/580,730

(22) PCT Filed: Nov. 29, 2004
(86) PCT No.: PCT/KR04/03109

§ 371 Date: Mar. 26, 2007

(30) Foreign Application Priority Data
Dec. 1, 2003 (KR) 10-2003-0086463

(51) Int. Cl. B82B 3/00

(52) U.S. Cl. 423/447.1; 977/742

(57) ABSTRACT

The present invention provides a method for preparing high purity carbon nanotubes, in which, when carbon nanotubes are prepared by the recombination of carbons generated from a carbon source in the presence or absence of a catalyst as in arc-discharge, laser ablation, chemical vapor deposition or vapor phase continuous growth method, and the like, water of 1 to 2000 wt % based on a carbon source is added in the reaction system to prepare high purity carbon nanotubes. According to the present invention, the addition of water in the reaction system suppresses the soot formation resulting from the pyrolysis of a carbon source itself and induces the oxidation or reduction of the formed soot by water, and thereby high purity carbon nanotubes can be prepared economically and easily.

### TECHNICAL FILED

The present invention relates to a method for preparing high purity carbon nanotubes by using water. More particularly, the present invention relates to the method for preparing high purity carbon nanotubes, in which, when carbon nanotubes are prepared by the recombination of carbons generated from solid carbon or a carbon source such as hydrocarbon in the presence or absence of catalyst, water is added into the reaction system so as to suppress the soot formation resulting from the pyrolysis of a carbon source itself and to induce an oxidation or reduction reaction of the formed soot by water, and thereby high purity carbon nanotubes are prepared.

### BACKGROUND ART

Since 1991 when a Japanese scientist, Dr. Iijima discovered the structure of carbon nanotubes, the research for synthesis, properties and applications of carbon nanotubes has been vigorously carried out until now. Carbon nanotubes (CNT) are in the form of a graphite sheet rolled into a cylinder with a diameter on nanometer scale, and they can be electric conductor or semiconductor depending on the angle at which the graphite sheet is rolled and the structure thereof. Also, the formation of the rolled graphite sheet can be varied depending on the existence and type of transition metals used in the synthesis thereof, and therefore carbon nanotubes can be classified into single-walled nanotubes, multi-walled nanotubes, and rope nanotubes.

The preparation methods for carbon nanotubes can be classified into two types. First, there is a method to prepare carbon nanotubes in the course of cooling after vaporizing solid-phase carbon such as graphite, including arc-discharge method, laser ablation method, and the like, depending on a method for vaporizing the solid-phase carbon. Secondly, there is a method to prepare carbon nanotubes from reaction gas containing carbon such as hydrocarbon with a catalyst by using a various methods of chemical vapor deposition, for example, pyrolytic vapor deposition, thermal chemical vapor deposition, plasma-enhanced chemical vapor deposition and the like [references: U.S. Pat. No. 5,424,054 (arc-discharge method); Chem. Phys. Lett. 243, 1-12, 1995 (laser ablation method); Science 273, 483-487, 1996 (laser ablation method); U.S. Pat. No. 6,210,800 (catalytic synthesis method); U.S. Pat. No. 6,221,330 (vapor-phase synthesis method); WO00/26138 (vapor-phase synthesis method)].

In the above-mentioned methods, carbon nanotubes are synthesized under severe reaction conditions such as high temperature of a few hundred to a few thousand degree, and thus the synthesized carbon nanotubes contain amorphous carbon particles and crystalline graphite particles which are called soot (herein below, all by-products formed of carbon except carbon nanotubes, which are generated during the preparation of carbon nanotubes, are referred to as ‘soot’). Practically, by-products such as soot can be inevitably produced in the synthetic mechanism of carbon nanotubes which comprises the step of pyrolysis of solid carbon or hydrocarbon used as carbon source and the step of recombination of carbons generated from the previous step thereof. That is, the decomposed solid carbon or hydrocarbon forms not only carbon nanotubes but also soot due to a high reaction temperature.

In order to obtain high purity carbon nanotubes, so far, there have been some proposed methods such as a method for purifying carbon nanotubes to remove soot co-produced with carbon nanotubes, a method for fundamentally suppressing the soot formation or removing the formed soot in the course of carbon nanotubes preparation, and the like.

As the preparation of carbon nanotubes, mention can be made of an oxidation method using a difference between the combustion temperatures of carbon nanotubes (about 500 to 700° C.) and the soot (about 300 to 500° C.), a purification method using ultrasonic wave, and the like. However, there is a disadvantage that the oxidation reaction is a radical reaction and thus it goes so vigorously that it is impossible to control the reaction even though two; materials, having a large difference in the combustion temperatures, are physically mixed, so it results in a considerably low yield.

As a method of suppressing the soot formation or removing the formed soot in the course of preparing carbon nanotubes, for example, there have been proposed methods such as a method of using hydrocarbon as a carbon source which produces less soot despite in pyrolysis, or a method of adding a reaction gas which can suppress the soot formation or remove the formed soot, for example H₂, O₂ or CO, with a carbon source, and the like.

However, these methods have a lot of problems because the reactivity of the reaction gas used for suppressing the soot formation is so high that a total yield of carbon nanotubes is considerably reduced, the added gas makes the reaction complicated and affects the preparation of carbon nanotubes, and the like.

On the other hand, methods of suppressing the soot formation using water have been studied in the field of combustion, internal combustion engine, and diesel engine.

There have been lots of results from the research that the addition of water to diesel fuel enhances the fuel-efficiency and decreases the generation of NOₓ (which is an air pollutant) as well as the soot formation.

G. Greeves et al. reported that the atomization and mixing of fuel during the process of explosion at high temperature inside a cylinder is enhanced by using diesel fuel mixed with water and that the formation of NOₓ and soot can be thereby suppressed at high temperature of internal cylinder [reference: Effects of Water Introduction on Diesel Engine Combustion and Emissions, 16^{th} Symposium International on Combustion, The Combustion Institute, 1976, pp. 321-336].

The above-mentioned phenomenon is due to the improvement in momentum of fuel by water particles, and also it has been well known that a highly-reactive OH radical, which is generated due to water pyrolysis, substantially suppresses the soot formation of hydrocarbons and contributes to remove the formed soot.

Further, Lin C Y et al. reported that the soot formation is considerably suppressed by using fuel for ship mixed with water [reference: J. Ship Res. 39(1995) 172].

### DETAILED DESCRIPTION OF THE INVENTION

The present inventor has found that the introduction of water to the reactor system with solid carbon or a carbon source like hydrocarbon by various methods, in the preparation of carbon nanotubes from solid carbon or a carbon source, can suppress the soot formation resulting from the pyrolysis of carbon sources and induce the oxidation or reduction of the formed soot, and high purity carbon nanotubes can be thus prepared; and then the present inventor has completed this invention.

According to the present invention, the soot formed during the synthesis of carbon nanotubes can be significantly reduced by adding water to a reaction system in previous carbon nanotube preparation processes, and thus the present invention can be easily applied to the existing preparation processes of carbon nanotubes, such as a continuous mass synthesis process of carbon nanotubes, a method for preparing carbon nanotubes in the presence of a catalyst which is fixed in a reactor, and the like.

Therefore, according to the present invention, high purity carbon nanotubes or graphitic nanofibers can be produced economically and easily without causing significant change in reaction conditions, which is different from the previous carbon nanotube preparation processes in which the soot formation is suppressed by adding a reaction gas (such as H₂ and the like) to a carbon source.

### SUMMARY OF THE INVENTION

An object of the present invention is to provide a method for preparing high purity carbon nanotubes in which the carbon nanotubes are prepared by the recombination of carbons generated from a carbon source such as solid carbon, graphite or hydrocarbon in the presence or absence of a catalyst, the method being characterized in adding water into the reaction system or making water exist in the reaction system.

In the present invention, the amount of water is not specifically limited unless it interrupts or disorders the preparation of carbon nanotubes. In the preferred embodiments of the present invention, water can be added in an amount of 1˜2000 wt %, particularly 30˜1000 wt %, preferably 50˜500 wt %, and more preferably 100˜300 wt %, based on the weight of a carbon source.

However, a person skilled in the pertinent art should clearly understand that the above-mentioned amounts of water are defined by considering vaporization energy of water and the like, and that, if necessary, water of 2000 wt % or more can be used.

The present invention will be now described in more detail.

In the present invention, the term ‘soot’, which consists of amorphous carbon particles and crystalline graphite particles, refers to non-crystallized fine carbon particles and all those including tiny carbon particles graphited but not grown to a carbon nanotubes.

In the present invention, carbon generated from a carbon source such as solid carbon, graphite or a hydrocarbon means one generated by a high temperature, arc-discharge, laser or plasma, for example, gas-phase carbon, however, it is not limited to atomic carbon and can include ionic or radical carbon.

In a previous method for preparing carbon nanotubes by recombining carbons generated from the pyrolysis of hydrocarbon or graphite, i.e., gas-phase carbons, the formation of soot as a by-product is inevitably induced due to the reaction mechanism. That is, a part of carbon generated by the decomposition of solid carbon or other carbon source, which is generally in gas phase, recombines as carbon nanotubes, and another part of the carbon forms soot due to high reaction temperature.

The present invention provides a method for preparing high purity carbon nanotubes without causing significant changes in previous carbon nanotube preparation methods and apparatus, which is characterized in simply adding water or making water exist in reaction systems used in previous preparation processes.

Generally, water causes various reactions with carbon or a hydrocarbon, for: example, the following reactions can be mentioned:

1. carbon-water reaction:
C+H₂O→CO+H₂ (1)

2. water-carbon monoxide reaction (water gas shift reaction):
CO+H₂O→CO₂+H₂ (2)

3. steam reforming reaction:
HC+H₂O→H₂+CO₂ (3)

4. coal gasification reaction:
Coal+H₂O→HC+CO+H₂ (4)

The above-mentioned reactions occur via the reaction of water with carbon or a hydrocarbon and progress at 150˜800° C. in a catalytic reaction but at 500° C. or higher in a non-catalytic reaction.

As in the carbon-water reaction (1) or coal gasification reaction (4) among the above-mentioned reaction (1) to (4), the reaction of water with solid-phase carbon can result in the fundamental prevention of the soot formation caused by the pyrolysis of a carbon source in the carbon nanotube preparation processes, and the reduction by water can result in the removal of the formed soot.

In addition, as in the steam reforming reaction (3), the soot formation by pyrolysis of a hydrocarbon itself as a carbon source can be prevented by the reaction of water with the hydrocarbon, and it is expected that an OH radical, which is a powerful oxidizing agent generated from the reaction of water with the carbon source during this reaction, can effectively prevent the transformation of carbon atom into soot and has an excellent effect on the oxidation reaction of soot. Generally, by injecting hydrogen gas with a carbon source, the purity of carbon nanotubes can be improved compared to the purity of carbon nanotubes prepared by using only a carbon source. However, there is a disadvantage that the yield of carbon nanotubes is considerably lowered because the reactivity of a hydrogen atom is so strong to react with most of carbon atoms (which are used for preparing carbon nanotubes) resulting from the decomposition by a catalyst. However, unlike hydrogen, the reactivity of water is moderate and therefore water makes it possible to prepare high purity carbon nanotubes without causing significant effects on the preparation of carbon nanotubes.

According to the present invention, by simply adding or injecting water into the reaction system without significant change of process conditions or apparatus in previous carbon nanotube preparation processes, the soot formation resulting from the pyrolysis of a hydrocarbon itself can be suppressed and a reduction reaction of the formed soot by water can be induced, and thus high purity carbon nanotubes can be prepared. The method according to the present invention can be simply applied to previous methods for preparing carbon nanotubes, such as a continuous gas-phase synthesis method, chemical vapor deposition, and the like. According to the present invention, therefore, it is possible to produce high purity carbon nanotubes or carbon nanofibers (GNF) easily and economically.

### BRIEF DESCRIPTION OF THE FIGURES

FIG. 1 is a SEM image of carbon nanotubes synthesized in Example 1.

FIG. 2 is a SEM image of carbon nanotubes synthesized in Example 2.

FIG. 3 is a SEM image of carbon nanotubes synthesized in Example 3.

FIG. 4 shows the result from analyzing the relative purity of carbon nanotube samples synthesized in Examples 2 & 3, respectively, using Raman spectroscopy.

FIG. 5 is a SEM image of carbon nanotubes prepared in Example 6 using a benzene solution containing water in which catalyst particles are uniformly dispersed.

FIG. 6 is a SEM image of carbon nanotubes prepared in Example 7 using a benzene solution without containing water in which catalyst particles are uniformly dispersed.

### DETAILED DESCRIPTION OF THE PREFERRED EMBODIMENT

The method of the present invention can be applied to previous processes in which carbon nanotubes are prepared by the recombination of carbons generated from a carbon source such as solid carbon or a hydrocarbon in the presence or absence of a catalyst. Specific modes of application methods for the present invention can be explained hereinafter but are not limited thereto.

Arc-Discharge Method

In an arc-discharge method, carbon nanotubes are prepared through discharging caused by applying an alternating or direct current between two carbon electrodes arranged horizontally or vertically. A direct current, which results in a high yield of carbon nanotubes, is mostly used, and a graphite rod with high purity is used as a carbon electrode. When graphite rods containing metal instead of pure graphite rods are used as anode, single-walled carbon nanotubes are synthesized. He or H₂ gas is used as an atmosphere gas and the morphology or yield of synthesized carbon nanotubes varies depending on the type of gas. If discharging is occurred while maintaining a moderate pressure (200 to 600 Torr for He), anode is consumed by discharging and a deposited material is formed on the surface of cathode. The deposited material comprises carbon nanotubes, graphite and the like.

In the arc-discharge method, water can exist beforehand in the reaction system, or can be added with an inert gas or separately. Water can be added continuously or in a batch manner. In the arc-discharge method, the amount of water used for decreasing the amount of soot is not limited specifically, but water can be added in the amount of generally 1˜2000 wt %, particularly 30˜1000 wt %, preferably 50˜500 wt %, and more preferably 100˜300 wt % of the graphite consumed in the reaction.

Laser Ablation Method

As a laser ablation apparatus, can be mentioned one that was first used for preparing carbon nanotubes by Smalley's group. While a high temperature of at least 3000° C. is required to vaporize graphite, a temperature of 1100˜1300° C. is required as an optimal temperature for preparing carbon nanotubes or fullerenes. Graphite rod placed in a furnace is vaporized by using laser, and then the deposition process is carried out in the furnace which is maintained at a temperature of about 1200° C. By using pure graphite rod, multi-walled carbon nanotubes can be synthesized, but by adding catalyst metal (such as Co, Ni, Y and the like) in the graphite rod, uniform single-walled carbon nanotubes can be synthesized.

In the laser ablation method, water can exist beforehand in the reaction system, or can be added with an inert gas or separately. Water can be added continuously or in a batch manner. In the laser ablation method, the amount of water used for decreasing the amount of soot is not limited specifically, but the water can be added in the amount of generally 1˜2000 wt %, particularly 30˜1000 wt %, preferably 50˜500 wt %, and more preferably 100˜300 wt % of a carbon source used in the reaction.

Chemical Vapor Deposition Method (CVD)

In the synthesis by chemical vapor deposition, a deposited material of carbon nanotubes is formed through the reaction of a gas-phase carbon source with catalyst particles. Therefore, the use of catalyst is essential, and metal such as Ni, Co, Fe and the like is mostly used. Because each catalyst particles acts as a seed to form carbon nanotubes, it is a core technique of the preparation of carbon nanotubes to form catalyst into particles of a few nanometer or a few tens of nanometer in size. As methods which have been previously used, the following methods can be mentioned: a method in which catalyst metal is deposited in the form of thin film followed by an aggregation with heat treatment, or a method of forming catalyst metal into particles by plasma etching or an etching solution. In addition, sol-gel method or a method in which catalyst metal is dissolved in a solution and then a substrate is coated with said solution. Further, mention can be made of a method of growing catalyst metal as particles, in which the catalyst metal is encapsulated in nanopores which are formed by etching Al substrate, etc. using an etching solution.

The growth of carbon nanotubes can be achieved in all the previous CVD apparatus such as PECVD (Plasma Enhanced CVD), thermal CVD, LPCVD (Low Pressure CVD), HFCVD (Hot Filament CVD) and the like. Most of carbon nanotubes synthesized by those methods are multi-walled carbon nanotubes and the formation of single-walled carbon nanotubes is very rare.

In such chemical vapor deposition methods, water can exist beforehand in the reaction system, or can be added with reaction gas or separately and continuously or intermittently. In the chemical vapor deposition method, the amount of water is not limited specifically, but water can be added in the amount of generally 1˜2000 wt %, particularly 30˜1000 wt %, preferably 50˜500 wt %, and more preferably 100˜300 wt % of a carbon source supplied into the reaction system.

Vapor Phase Growth Method

Carbon nanotubes can be synthesized continuously in vapor phase by supplying a catalyst of fine particles with a carbon source continuously into the reactor. For example, the present applicant's international patent application (WO03/008331, date of publication: Jan. 30, 2003) discloses a method of continuous vapor phase growth of carbon nanotubes, characterized in preparing a colloidal solution containing catalyst nanoparticles and then supplying this solution with a carbon source into a heated reactor in vapor phase, which is included herein as a reference.

A method of introducing water into the reaction system can include spraying or atomizing water through a separate water-injection port, injecting water in the form of a mixture or emulsion with a hydrocarbon as a carbon source, and the like, but is not limited thereto. In the present invention, an oil-in-water or water-in-oil emulsion is preferred, which can be prepared from water and an organic solvent which acts as a carbon source by using a surfactant, since the carbon source and water are present as a very homogeneous solution. Although the amount of water is not limited specifically, water can be added in the amount of generally 1˜2000 wt %, particularly 30˜1000 wt %, preferably 50˜500 wt %, and more preferably 100˜300 wt % of a carbon source supplied into the reaction system.

According to one modification of the present invention, an oil-in-water or water-in-oil emulsion prepared from water and an organic solvent as a carbon source by using a surfactant can preferably contain catalyst metal particles in nanometer size (referred to as catalyst metal nanoparticles, hereinafter). Catalyst metal nanoparticles can be present being simply dispersed in the emulsion medium or encapsulated inside particles of water-in-oil or oil-in-water emulsion, for example, metal particle-in water-in-oil or metal-in oil-in water, or their mixture. When catalyst metal particles are encapsulated inside emulsion particles, the dispersiveness of water and catalyst metal particles can be enhanced, and consequently, the catalyst metal particles can be more uniformly distributed when injected into the reactor so that very uniform and high purity carbon nanotubes can be synthesized.

The type of catalyst which can be used in the present invention is not limited specifically, and as examples, can be mentioned the above-mentioned metal elements, their oxides, nitrides, borides, fluorides, bromides and sulfides, and their mixture. In addition, metal particles comprising at least two metal species can be prepared in the form of a complex or alloy, and the particle size and distribution of metal salt micelle can be easily controlled depending on the types of a solvent and a surfactant and the amounts of use thereof. In the present invention, if necessary, other metal, which does not act as a catalyst during the process of preparing carbon nanotubes, can be added in the form of an alloy or mixture with the metal acting as a catalyst.

In the present invention, water, or a polar or nonpolar organic solvent can be mentioned as a solvent used for preparing the colloidal solution of catalyst nanoparticles. The polar or nonpolar organic solvent can be selected from the group consisting of aromatic organic solvents such as benzene, toluene or xylene, aliphatic organic solvents such as hexane, heptane or octane, polar solvents such as ethanol, propyl alcohol, and their mixture.

In the present invention, a catalyst, water and/or a carbon source, or a colloidal solution comprising them can be introduced alone or with a carrier into the reactor. As a carrier, mention can be made of an inert gas such as Ar, Ne, He or N₂; or the above-mentioned polar or nonpolar organic solvent.

In the present invention, catalyst nanoparticles or a colloidal solution comprising the catalyst nanoparticles can be prepared by methods known in the pertinent art, such as mechanical grinding, co-precipitation, atomization, a sol-gel method, electrolysis, emulsion method, reverse phase emulsion method, etc, and also mention can be made of the method described in WO 03/008331 which is the publication of the international patent application of the present applicant or the method described in U.S. Pat. No. 5,147,841, which are included herein as a reference.

In the present invention, as a carbon source which can be in liquid phase or gas phase, the above-mentioned surfactant or organic solvent can be used as it is, and also CO or other hydrocarbon, for example, an organic compound selected from group consisting of saturated or unsaturated aliphatic hydrocarbons having 1 to 6 carbon atoms or aromatic hydrocarbons having 6 to 10 carbon atoms, can be used. These carbon sources can have 1 to 3 heteroatoms selected from the group consisting of O, N, F, Cl and S.

According to one preferred embodiment of the present invention, a special gas (such as H₂, H₂S, or NH₃) can be supplied with water and a carbon source. The amount of the special gas is not limited specifically and can be used in a moderate amount which is generally used in the pertinent art.

Another advantage of the present invention is the suppression of catalyst deactivation. Generally, in the process of preparing carbon nanotubes using a catalyst, there has been reported a catalyst deactivation phenomenon that a catalyst can not react with a carbon source any more due to the formation of amorphous carbon thin films resulting from polymerization at a l;w temperature of 500° C. or lower or the formation of a carbon layer surrounding the catalyst which results from the excessive pyrolysis of a hydrocarbon at a high temperature of 600° C. or higher. That is to say, the catalyst deactivation occurs when the decomposition rate of a carbon source (i.e., the formation rate of carbon) is higher than the formation rate of carbon nanotubes on the surface of the catalyst on which a carbon source (such as a hydrocarbon) is decomposed. According to the present invention, the catalyst deactivation can be prevented to some extent by adding water into the reaction system to suppress the soot formation on the catalyst surface and remove the formed soot. Even though the addition of hydrogen into the reaction system have some effect to prevent such catalyst deactivation, hydrogen has a disadvantage that hydrogen can cause another problem in the reaction system, as mentioned above.

In the present invention, such catalyst deactivation phenomenon is suppressed by adding water and thus the catalyst lifetime is long, which is advantageous in preparing carbon nanofibers.

As further advantage of the present invention, since water has a lower reactivity than other reaction gas (such as hydrogen) which is added to suppress the soot formation or remove the formed soot, the amount of added water is not defined precisely and can be decided within a considerably wide range, and also it is not fatal to the reaction even though the amount of added water is not controlled precisely being changeable within a considerably wide range during the reaction; therefore, it is not tightly controlled to carry out the reaction.

The present invention will be now described in more detail with reference to the following examples but not limited thereto.

### EXAMPLES

### Example 1

(a) Preparation of Catalyst: Alumina powder having a surface area of 250 m²/g was impregnated with an aqueous solution of Fe(NO₃)₂ and Co(NO₃)₂ and then calcined at 300° C. under an air atmosphere. The obtained catalyst comprises 5 wt % of each of iron and cobalt.

(b) Preparation of Carbon Nanotubes: The alumina catalyst of 0.2 g co-impregnated with iron and cobalt which was prepared in (a) was put into a quartz boat and then placed at the center of a quartz tube reactor (with 27 mm in diameter) located in an electric furnace. Then, the reactor temperature was raised to 1000° C. with flowing He gas in a rate of 100 mL/min. When the reactor temperature reached to 1000° C., 2 vol % of benzene and 10 vol % of water which were respectively vaporized by He gas were injected into the reactor, and then the synthesis of carbon nanotubes was carried out for 30 min.

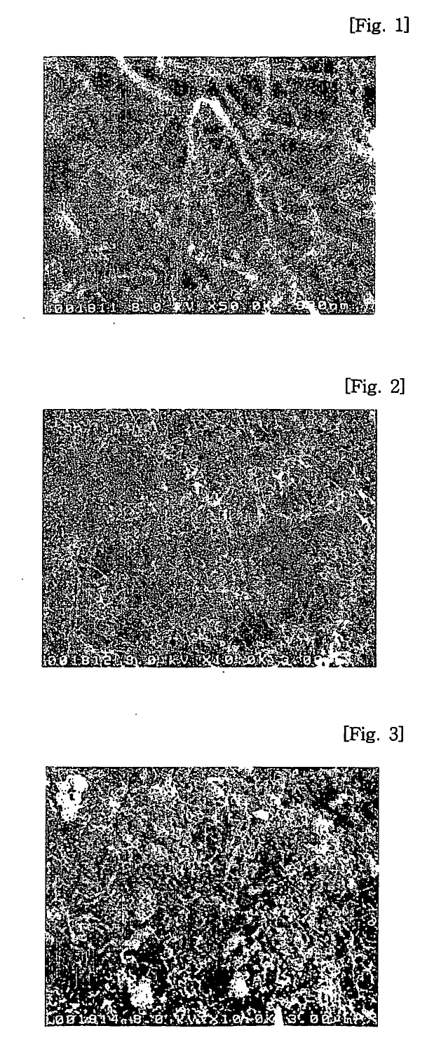

The presence of carbon nanotubes mixed with about 20% soot as an impurity was confirmed by analyzing the obtained product using a scanning electron microscopy (SEM). FIG. 1 is a SEM image of carbon nanotubes prepared in Example 1.

### Example 2

An emulsion solution in which benzene nanopartices are distributed uniformly was prepared by dissolving 5 g of cetyltrimethylammonium bromide (CTAB) in 100 mL of water and then mixing with 10 mL of Benzene. 0.2 g of catalyst as prepared in Example 1 was put into a quartz boat and then placed at the center of a quartz tube reactor with 27 mm in diameter. Then, the reactor temperature was raised to 1000° C. under flowing He gas in a rate of 100 mL/min. When the reactor temperature reached to 1000° C., the synthesis of carbon nanotubes was carried out for 30 min by injecting a benzene emulsion solution (prepared above) in a rate of 0.34 mL/min into the reactor.

According to the result from analyzing the obtained product using SEM, it was found that the soot formation is reduced in comparison with Example 1, but carbon nanotubes having an average diameter of 1.2 nm, which are the same as in Example 1, were found to be prepared according to the result from analyzing the obtained product using a transmission electron microscopy (TEM).

FIG. 2 is a SEM image of carbon nanotubes prepared in Example 2.

### Example 3 (Comparative)

In order to examine the role of water in preparing high purity carbon nanotubes, carbon nanotubes were synthesized under the same reaction conditions by using the same catalyst as in Example 1. In this Example, benzene was vaporized by He gas to be 2 vol % and then injected into the reactor without injecting water. The reaction was carried out at 1000° C. for 30 min.

According to the result from analyzing the obtained product using SEM, it was found that a considerable amount of soot particles coexist with carbon nanotubes. In addition, according to the result from analyzing the obtained product using TEM, it was found that the carbon nanotubes have an average diameter of about 1.2 nm.

FIG. 3 is a SEM image of carbon nanotubes prepared in Example 3.

In the SEM images (FIGS. 1 and 2) of the carbon nanotubes which were synthesized with injecting water, no existence or very small amount of soot was found. On the contrary, in the SEM image (FIG. 3) of carbon nanotubes which were synthesized without injecting water in the presence of an organic solvent (such as benzene), it was found that the soot is present in a considerable amount.

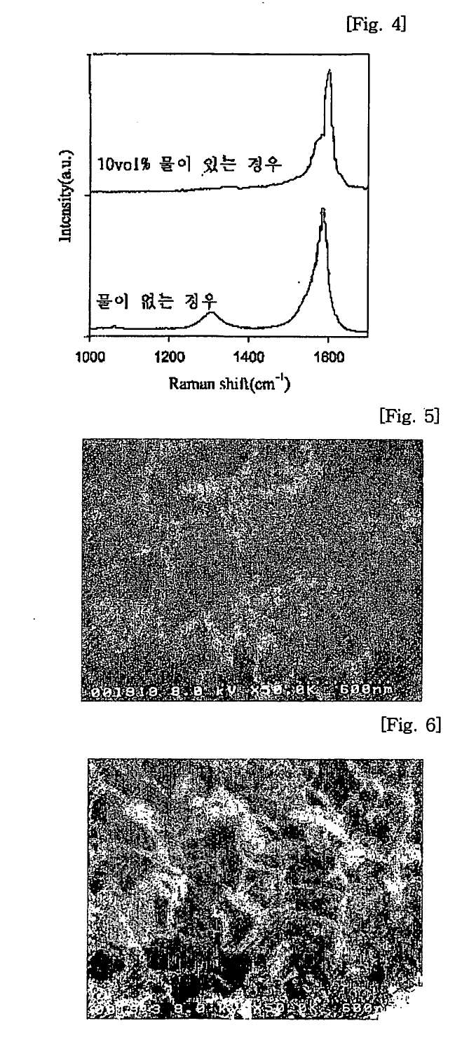

FIG. 4 shows the result from analyzing the purity of carbon nanotubes obtained in Examples 2 & 3 using a Raman spectroscopy. G-band signal (1590 cm⁻¹) resulting from carbon nanotubes and D-band signal(1360 cm⁻¹) indicating the amount of soot as an impurity were set in the same scale and then the magnitudes of the two signals were compared to each other. The D-band signal is hardly seen in Example 2, whereas a considerable magnitude of this signal is detected in Example 3. This result demonstrates that the carbon nanotubes obtained in Example 3 have much more impurities as compared to those obtained in Example 2. The comparisons of the purity of carbon nanotubes using a Raman spectroscopy is referred to the literature [S. Maruyama et al., Chemical Physics Letters, 360 (2002), 229]

In conclusion, the carbon nanotubes which were prepared in Example 2 with adding water had almost no impurities, which demonstrates that high purity carbon nanotubes were prepared. This result is consistent with the analysis using SEM and TEM.

### Example 4

Using a catalyst which was prepared in the same manner as in Example 1, 5 vol % of acetylene as a carbon source was injected with 10 vol % of water at the reaction temperature of 800° C., and then the synthesis of carbon nanotubes was carried out. According to the analysis result, it was found that high purity carbon nanotubes having an average diameter of 2 nm were obtained. In addition, the result from the SEM analysis shows that carbon nanotubes prepared with injecting water into the reactor have much less amount of soot than carbon nanotubes prepared with injecting only acetylene 5 vol % with no water, which demonstrates that high purity carbon nanotubes were prepared.

### Example 5

Using the method as described in Example 1, 1 vol % of benzene as a carbon source and 10 vol % of water respectively vaporized by He gas were injected into the reactor and, and then the synthesis of carbon nanotubes was carried out. According to the analysis result, it was found that high purity carbon nanotubes having an average diameter of 2 nm were obtained. In addition, according to the result from the SEM analysis, the amount of the formed soot was less than 5%.

In the carbon nanotubes prepared with injecting only 1 vol % of benzene without injecting water, the formation of about 20% soot was observed. The SEM analysis shows that the soot amount is small when water is added as a reaction component and thus high purity carbon nanotubes are prepared.

### Example 6

A benzene solution was prepared by adding 1.46 g of CTAB (0.1 M) and 5.93 g of butanol (20 times of the CTAB amount) into 40 mL benzene. An aqueous solution was prepared by dissolving 0.065 g of FeCl₃ (0.01M) based on the amount of benzene into 5.76 g of water (80 times of the CTAB amount). An emulsion was prepared by mixing the obtained benzene solution and aqueous solution, and then 0.046 g of NaBH₄ (three times of the FeCl₃ amount) was added in the emulsion with uniformly mixing to prepare a microemulsion solution in which iron particles were uniformly distributed. Herein, CTAB is a cationic surfactant which stabilizes formed nanoparticles, butanol is a cosurfactant, and NaBH₄ is a reducing agent to reduce Fe ions into the metallic state.

The above-mentioned solution is a stabilized solution in which Fe particles having an average diameter of 6 nm are dispersed and water particles are present very uniformly being stabilized by butanol acting as a cosurfactant although benzene and water were mixed.

Introducing the obtained solution (0.34 mL/min) with a carrier gas (Ar, a flow rate: 100 sccm) for 20 min into the reactor having its internal temperature of 1000° C., the preparation reaction of carbon nanotubes was carried out to obtain a product in black-powder form.

FIG. 5 is the SEM image of carbon nanotubes prepared by using the water-containing benzene solution in which catalyst metal particles are uniformly dispersed.

It has been generally known that lots of soot is formed when benzene is used as a carbon source; however, based on the result from the preparation of car bon nanotubes by adding water, it was found that the amount of soot was as small as that in the case of using other carbon sources.

### Example 7 (Comparative)

Carbon nanotubes were prepared under the same conditions as in Example 6 except using a benzene solution in which Fe particles were uniformly distributed, the benzene solution prepared by using only a small amount of water involved in the FeCl₃ reduction. FIG. 6 is a SEM image of carbon nanotubes prepared by using the benzene solution without water in which catalyst metal particles were uniformly dispersed. It was found that a large amount of soot was present with the carbon nanotubes.

Upon comparing the results from Example 6 with that of Example 7, it was found that the soot amount is significantly small in Example 6 in which water is involved in the reaction.

### Example 8

Except using hexane instead of benzene, a solution was prepared in the same manner as in Example 6, and the obtained result was the same as in Example 6.

### Example 9

A benzene solution was prepared by adding 1.46 g of CTAB (0.1M) and 5.93 g of butanol (0.2M) into 40 mL benzene. An aqueous solution was prepared by dissolving 0.095 g of CoCl₂.6H₂O (0.01M) based on benzene into 1.44 g of water (20 times of the CTAB amount). An emulsion was prepared by mixing the obtained benzene solution and aqueous solution.

In the same manner, a solution was prepared by using 0.031 g of Na₂S (0.01M) instead of CoCl₂.6H₂O.

By mixing the two benzene solutions obtained above, a microemulsion solution was prepared in which CoS particles were uniformly distributed.

The above-mentioned solution was a stabilized solution in which CoS particles having an average diameter of 4 nm and water particles were present in the very uniform state being stabilized by butanol acting as a cosurfactant, although benzene and water were mixed.

Introducing the obtained solution (0.34 mL/min) with a carrier gas (Ar, a flow rate: 100 sccm) for 20 min into the reactor having its internal temperature of 1000° C., the preparation reaction of carbon nanotubes was carried out to obtain a product in black powder form.

From the SEM and TEM analyses of the obtained product, it was found that the carbon nanotubes having a average diameter of 10 nm were prepared and that the amount of soot as a impurity was less than 5% of the overall product.

### Example 10

A homogeneous solution was prepared by adding 3.516 g (10 wt %, based on ethanol) of polyoxyethylene(20) sorbitan monolaurate (Tween®-20) and 0.0648 g (0.4 mmol, the amount to make a 0.01 M benzene solution) of FeCl₃ into 10 mL of water and 40 mL of ethanol, followed by adding 0.052 g of CoCl₂. (0.4 mmol, the amount to make a 0.01M benzene solution) of To this solution, 0.091 g of (2.4 mmol) NaBH₄ was added to prepare a homogeneous solution in which Fe—Co nanoparticles were present in the form of alloy. Herein, Tween®-20 was used as a nonionic surfactant to stabilize the formed nanoparticles and NaBH₄ was used as a reducing agent to reduce metal ions.

While introducing the obtained solution (0.34 mL/min) with a carrier gas (Ar, a flow rate: 100 sccm) for 20 min into the reactor having its internal temperature of 800° C., the preparation reaction of carbon nanotubes was carried out to obtain a product in black powder form.

From the SEM and TEM analyses of the obtained product, it was found that the carbon nanotubes having a average diameter of about 10 nm were prepared and that the amount of soot as a impurity was less than 10% of the overall product.

### Example 11

A solution was prepared as in Example 10 except using water 40 mL and ethanol 10 mL, in which Fe and Co nanoparticles were dispersed uniformly in the form of alloy in the same manner as in Example 9.

While introducing the obtained solution (0.34 mL/min) without a carrier gas for 20 min into the reactor having its internal temperature of 800° C., the preparation reaction of carbon nanotubes was carried out to obtain a product in black powder form.

From the SEM and TEM analyses of the obtained product, it was found that the carbon nanotubes having an average diameter of about 10 nm were prepared and that the amount of soot as an impurity was less than 10% of the overall product.

In the present experiment, water acts the role as a carrier to introduce a carbon source into the reactor as well as the role to suppress the soot formation.

1. A method for preparing high purity carbon nanotubes in which the carbon nanotubes are prepared by the recombination of carbons generated from a carbon source such as solid carbon, graphite or a hydrocarbon in the presence or absence of a catalyst, the method being characterized in adding water into the reaction system or making water exist in the reaction system.

2. The method according to claim 1, characterized in that water is supplied into the reaction system with the carbon source or separately.

3. The method according to claim 1, characterized in that water is present in an amount of 1 to 2000 wt % based on the total weight of the carbon source.

4. The method according to claim 1, characterized in that the catalyst is at least one metal selected from the group consisting of transition metal, noble metal, alkali metal and alkali earth metal.

5. The method according to claim 1, characterized in that the graphite as a carbon source is vaporized by arc-discharge or laser ablation.

6. The method according to claim 1, characterized in that the hydrocarbon as a carbon source is supplied in gas phase.

7. The method according to claim 1, characterized in that the catalyst is supplied continuously or intermittently in the form of nanoparticles or a colloid solution thereof.

8. The method according to claim 7, characterized in that the colloid solution is a solution of the catalyst nanoparticles which are dispersed in a solvent selected from the group consisting of water, a nonpolar organic solvent, such as aromatic organic solvent such as benzene, toluene or xylene, or an aliphatic organic solvent such as hexane, heptane or octane, a polar organic solvent such as ethanol or propyl alcohol, and a mixture thereof in the presence of a surfactant.

9. The method according to claim 7, characterized in that the catalyst in the form of nanoparticles is selected from the group consisting of metal element, oxides, nitride, borides, fluorides, bromides and sulfides of metal and a mixture thereof.

10. The method according to claim 1, characterized in that water is added in the form of water-in-oil or oil-in-water emulsion with the hydrocarbon used as a carbon source in the presence of a surfactant.

11. The method according to claim 10, characterized in that the water-in-oil or oil-in-water emulsion comprises the catalyst nanoparticles which are dispersed in the emulsion medium or encapsulated inside particles of the water-in-oil or oil-in-water emulsion.

12. The method according to claim 10, characterized in that the surfactant is selected from the group consisting of hydrocarbon-, silicon- and fluorocarbon-based surfactants being cationic, anionic, nonionic or amphoteric.

13. The method according to claim 1, characterized in that the carbon source is selected from the group consisting of said solvents, said surfactants, carbon monoxide, saturated or unsaturated aliphatic hydrocarbons having 1 to 6 carbon atoms, and aromatic hydrocarbons having 6 to 10 carbon atoms; and said carbon source can have 1 to 3 heteroatoms selected from the group consisting of oxygen, nitrogen, chlorine, fluorine and sulfur.

14. The method according to claim 13, characterized in that the hydrocarbon is selected from the group consisting of aromatic hydrocarbons such as benzene, toluene or xylene, aliphatic hydrocarbons such as hexane, heptane or octane, alcohols such as methanol, ethanol or propyl alcohol, ketones such as acetone, and a mixture thereof.

15. The method according to claim 1, characterized in that an optional reaction gas selected from H₂, H₂S and NH₃ is supplied.
